(19) United States
(12) Patent Application Publication
(10) Pub. No.: US 2022/0095194 A1
(43) Pub. Date: Mar. 24, 2022

(54) SYSTEMS, DEVICES, AND METHODS FOR HANDLING RADIO LINK FAILURES IN WIRELESS RELAY NETWORKS

(71) Applicant: SHARP KABUSHIKI KAISHA, Sakai City, Osaka (JP)

(72) Inventors: JIA SHENG, Vancouver, WA (US); JOHN MICHAEL KOWALSKI, Vancouver, WA (US); TATSUSHI AIBA, Sakai City, Osaka (JP); KAZUNARI YOKOMAKURA, Sakai City, Osaka (JP)

(21) Appl. No.: 17/280,458

(22) PCT Filed: Sep. 20, 2019
(86) PCT No.: PCT/JP2019/037105

§ 371 Date: Mar. 26, 2021

(51) Int. Cl. H04W 36/30; H04W 36/08; H04W 76/19; H04W 88/14; H04W 92/20

(52) U.S. Cl. CPC H04W 36/305; H04W 36/08; H04W 92/20; H04W 88/14; H04W 76/19

(57) ABSTRACT

A method of handling Radio Link Failures (RLF) in Wireless Relay Networks is described. The method includes detecting, by a first parent node, a potential RLF with another node based on receiving from a physical layer of the first parent node a notification of “out-of-sync” indication signals. The method further includes determining, by the first parent node, a message comprising an Upstream Potential RLF notification based on whether a set of one or more conditions is met. The method further includes transmitting, by the first parent node, the message comprising an Upstream Potential RLF notification to at least one of a child node and a second parent node. The method further includes establishing, by the second parent node, an RRC connection with the child node based on the transmitted Upstream Potential RLF notification.

### TECHNICAL FIELD

The present embodiments relate to Integrated Access and Backhaul and backhauling for New Radio (NR) networks having Next generation NodeB capabilities and signaling. In particular, the present embodiments relate to a backhaul infrastructure and design for User Equipment and relay networks to handle Radio Link Failures.

### BACKGROUND ART

In typical cellular mobile communication systems and networks, such as Long-Term Evolution (LTE) and New Radio (NR), a service area is covered by one or more base stations, where each of such base stations may be connected to a core network by fixed-line backhaul links (e.g., optical fiber cables). In some instances, due to weak signals from the base station at the edge of the service area, users tend to experience performance issues, such as: reduced data rates, high probability of link failures, etc. A relay node concept has been introduced to expand the coverage area and increase the signal quality. As implemented, the relay node may be connected to the base station using a wireless backhaul link.

In 3^{rd} Generation Partnership Project (3GPP), the relay node concept for the fifth generation (5G) cellular system has been discussed and standardized, where the relay nodes may utilize the same 5G radio access technologies (New Radio (NR)) for the operation of services to User Equipment (UE) (access link) and connections to the core network (backhaul link) simultaneously. These radio links may be multiplexed in time, frequency, and/or space. This system may be referred to as Integrated Access and Backhaul (IAB).

Some such cellular mobile communication systems and networks may comprise IAB-donors and IAB-nodes, where an IAB-donor may provide interface to a core network to UEs and wireless backhauling functionality to IAB-nodes; and additionally, an IAB-node may support wireless access to UEs and wirelessly backhaul the access traffic. IAB-nodes may need to periodically perform inter-IAB-node discovery to detect new IAB-nodes in their vicinity based on cell-specific reference signals (e.g., Single-Sideband SSB). The cell-specific reference signals may be broadcasted on a Physical Broadcast Channel (PBCH) where packets may be carried or broadcasted on the Master Information Block° (MIB) section.

Demand for wireless traffic has increased significantly over time and IAB systems are expected to be reliable and robust against various kinds of possible failures. Considerations have been given for IAB backhaul design. In particular, to provide methods and procedures to address radio link failures on the backhaul link.

### SUMMARY OF INVENTION

In one example, a method of handling Radio Link Failures (RLF) in Wireless Relay Networks, the wireless relay network having a donor node wherein the donor node is an Integrated Access and Backhaul (IAB) node connected to a core network, a first parent node (IAB-node A), a second parent node (IAB-node B), a child node (IAB-node/UE), the method comprising: detecting, by the first parent node, a potential RLF with another node based on receiving from the physical layer of the first parent node a notification of “out-of-sync” indication signals, wherein the notification of the “out-of-sync” indication signals is determined based on at least one of: measurement of radio link strength and measurement of radio link quality; determining, by the first parent node, a message comprising an Upstream Potential RLF notification based on whether a set of one or more conditions is met; transmitting, by the first parent node, the message comprising an Upstream Potential RLF notification to at least one of: the child node and the second parent node; and establishing, by the second parent node, an RRC connection with the child node based on the transmitted Upstream Potential RLF notification.

In one example, a wireless node equipped with at least two radio interfaces comprising a first interface and a second interface, the first interface being configured to establish a first radio link with at least one parent node, the second interface being configured to establish a second radio link(s) with one or more wireless terminals, the wireless node having a processor circuitry and addressable memory, the processor configured to: detecting, by a first parent node, a potential RLF with another node based on receiving from the physical layer of the first parent node a notification of “out-of-sync” indication signals, wherein the notification of the “out-of-sync” indication signals is determined based on at least one of: measurement of radio link strength and measurement of radio link quality; determining, by the first parent node, a message comprising an Upstream Potential RLF notification based on whether a set of one or more conditions is met; transmitting, by the first parent node, the message comprising an Upstream Potential RLF notification to at least one of: a child node and a second parent node; and establishing, by the second parent node, an RRC connection with the child node based on the transmitted Upstream Potential RLF notification.

### BRIEF DESCRIPTION OF DRAWINGS

The various embodiments of the present embodiments now will be discussed in detail with an emphasis on highlighting the advantageous features. These embodiments depict the novel and non-obvious aspects of the invention shown in the accompanying drawings, which are for illustrative purposes only. These drawings include the following figures, in which like numerals indicate like parts.

FIG. 1 illustrates a mobile network infrastructure using 5G signals and 5G base stations.

FIG. 2 depicts an example of functional block diagrams for the IAB-donor and the IAB-node.

FIG. 3 illustrates Control Plane (C-Plane) and User Plane (U-Plane) protocols among the UE, IAB-nodes, and IAB-donor.

FIG. 4 depicts a functional block diagram of an example protocol stack configuration for the U-Plane.

FIG. 5A depicts a functional block diagram of an example protocol stack configuration for the C-Plane between an IAB-node connected to an IAB-donor.

FIG. 5B depicts a functional block diagram of an example configuration of the C-Plane protocol stack for an IAB-node connected to another IAB-node which is connected to an IAB-donor.

FIG. 5C depicts a functional block diagram of an example configuration of the C-Plane protocol stack for a UE's RRC signaling.

FIG. 6A depicts an example message sequence for an IAB-node to establish an RRC connection, followed by F1-AP* connection.

FIG. 6B depicts an example message sequence for IAB-node to establish an RRC connection with an IAB-donor, followed by the F1 setup procedure.

FIG. 7 shows an example diagram of a scenario where an IAB-node detects a Radio Link Failure (RLF) on the upstream link to its parent node.

FIG. 8 illustrates an example flow of information transmit/receive and/or processing by a UE and/or IAB-node connected to a set of IAB-nodes in communication with an IAB-donor, for processing a notification of an RLF.

FIG. 9A illustrates an example flow of information transmit/receive and/or processing by a UE and/or IAB-node connected to a set of IAB-nodes in communication with an IAB-donor, based on receiving an Upstream RLF notification.

FIG. 9B illustrates another example flow of information transmit/receive and/or processing by a UE and/or IAB-node connected to a set of IAB-nodes in communication with an IAB-donor, based on not having received an Upstream RLF notification.

FIG. 10A shows an example scenario for Upstream Potential RLF notification, a notification based on higher layers on the IAB-node having determined that a number of “out-of-sync” indications from the lower layer(s) have reached a threshold.

FIG. 10B shows another example scenario where the parent node detects a certain number of consecutive “out-of-sync” indications and starts the timer T2.

FIG. 10C shows another example scenario for Upstream Potential RLF notification, where the notification is based on higher layers on the IAB-node having determined that a number of PRACH preamble transmission attempts have failed.

FIG. 10D shows another example scenario for Upstream Potential RLF notification, where the notification is based on higher layers on the IAB-node having determined that a number of RLC Layer Data transmission attempts have failed.

FIG. 10E depicts an example message sequence for a parent IAB-node in communication with another parent IAB-node and UE/IAB Child node for processing of Upstream Potential RLF notification.

FIG. 10F depicts another example message sequence for a parent IAB-node in communication with a group of other parent IAB-nodes and UE/IAB Child node for processing of Upstream Potential RLF notification.

FIG. 11 illustrates an example of a set of components of a user equipment or base station.

FIG. 12 illustrates a mobile network infrastructure where a number of UEs are connected to a set of IAB-nodes and the IAB-nodes are in communication with each other and/or an IAB-donor.

FIG. 13 illustrates an example top level functional block diagram of a computing device embodiment.

FIG. 14 is a flowchart depicting an exemplary process for handling an RLF in an example of a wireless relay network.

FIG. 15A is a functional block diagram of a wireless node device which may be a parent IAB-node that may be in communication with an IAB-donor upstream and a UE and/or child IAB-node downstream.

FIG. 15B is a functional block diagram of a wireless terminal device which may be an IAB-node in communication with an IAB-donor or a parent IAB-node upstream.

FIG. 16 is a diagram illustrating an example of a radio protocol architecture for the control and user planes in a mobile communications network.

### DESCRIPTION OF EMBODIMENTS

The various embodiments of the present Systems, Devices, and Methods for Handling Radio Link Failures in Wireless Relay Networks have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

Embodiments disclosed provide methods and systems for handling a scenario where an Integrated Access and Backhaul (IAB) node, for example, an IAB-parent node and/or an IAB-child node, loses the connection or potentially loses connection to the network due to a radio link failure or potential radio link failure. The disclosed embodiments provide a method for the IAB nodes (e.g., IAB-parent) to transmit information representing radio conditions of the upstream link to the child nodes and/or UEs of the IAB-node. The child nodes and/or UEs may, based on the received information, for example, Upstream RLF notification or Upstream Potential RLF notification representing radio conditions, determine whether or not to stay on the current serving IAB-node or select another cell/IAB-node. In other embodiments, the parent nodes may determine an alternative parent node to serve the child node if an Upstream Potential RLF notification is determined and sent and/or transmitted. That is, via the information received from the IAB-nodes the parent nodes and/or child nodes and/or UEs may determine whether to initiate a random access procedure by an alternate parent node to the child nodes or attempt to select another cell/IAB-node to reestablish a connection with. In some embodiments, the child nodes and/or UEs may be expecting that the serving IAB-node may recover the upstream radio link during a waiting duration, however the waiting duration may be decreased by the present embodiments providing a method to reduce the time for downstream child IAB-nodes and/or UEs to respond to an upstream RLF. In some embodiments, the information representing the radio condition of the upstream link of the IAB-node may be based on signal strength, for example, Reference Signal Received Power (RSRP)/Reference Signal Received Quality (RSRQ) levels, and an associated threshold, which may be measured and provided by the lower layers, e.g., Physical layer to the higher layers. As part of the embodiments for decreasing the time it may take for a child node and/or UE to reestablish a connection after receiving an RLF notification, potential upstream RLF may be predicted by the parent node's higher layers and a notification transmitted to the child nodes and/or UEs so as to provide a notification earlier in time than an upstream RLF notification. Thereby extra time for processing by the child nodes and/or UEs is provided based on the parent node's prediction of potential radio link strength/quality problems.

The various embodiments of the present Systems, Devices, and Methods for Handling Radio Link Failures in Wireless Relay Networks now will be discussed in detail with an emphasis on highlighting the advantageous features. Additionally, the following detailed description describes the present embodiments with reference to the drawings.

A mobile network used in wireless networks may be where the source and destination are interconnected by way of a plurality of nodes. In such a network, the source and destination may not be able to communicate with each other directly due to the distance between the source and destination being greater than the transmission range of the nodes. That is, a need exists for intermediate node(s) to relay communications and provide transmission of information. Accordingly, intermediate node(s) may be used to relay information signals in a relay network, having a network topology where the source and destination are interconnected by means of such intermediate nodes. In a hierarchical telecommunications network, the backhaul portion of the network may comprise the intermediate links between the core network and the small subnetworks of the entire hierarchical network. Integrated Access and Backhaul (IAB) Next generation NodeB use 5G New Radio communications such as transmitting and receiving NR User Plane (U-Plane) data traffic and NR Control Plane (C-Plane) data. Both, the UE and gNB may include addressable memory in electronic communication with a processor. In one embodiment, instructions may be stored in the memory and are executable to process received packets and/or transmit packets according to different protocols, for example, Medium Access Control (MAC) Protocol and/or Radio Link Control (RLC) Protocol.

In some aspects of the embodiments for handling of radio link failures in wireless relay networks, disclosed is a Mobile Termination (MT) functionality typically provided by the User Equipment (UE) terminals that may be implemented by Base Transceiver Stations (BTSs or BSs) nodes, for example, IAB nodes. In one embodiment, the MT functions may comprise common functions such as: radio transmission and reception, encoding and decoding, error detection and correction, signaling, and access to a SIM.

In a mobile network, an IAB child node may use the same initial access procedure (discovery) as an access UE to establish a connection with an IAB node/donor or parent thereby attaching to the network or camping on a cell. In one embodiment, Radio Resource Control (RRC) protocol may be used for signaling between 5G radio network and UE, where RRC may have at least two states (e.g., RRC_IDLE and RRC_CONNECTED) and state transitions. The RRC sublayer may enable establishing of connections based on the broadcasted system information and may also include a security procedure. The U-Plane may comprise of PHY, MAC, RLC and PDCP layers.

Embodiments of the present system disclose methods and devices for an IAB-node to inform child nodes and/or UEs of upstream radio conditions and accordingly, the term IAB-node may be used to represent either a parent IAB-node or a child IAB-node, depending on where the IAB-node is in the network communication with the IAB-donor which is responsible for the physical connection with the core network. Embodiments are disclosed where an IAB-node (child IAB-node) may follow the same initial access procedure as a UE, including cell search, system information acquisition, and random access, in order to initially set up a connection to a parent IAB-node or an IAB-donor. That is, when an IAB base station (eNB/gNB) needs to establish a backhaul connection to, or camp on, a parent IAB-node or an IAB-donor, the IAB-node may perform the same procedures and steps as a UE, where the IAB-node may be treated as a UE but distinguished from a UE by the parent IAB-node or the IAB-donor.

In the disclosed embodiments for handling radio link failures in wireless relay networks, MT functionality typically offered by a UE may be implemented on an IAB-node. In some examples of the disclosed systems, methods, and device embodiments, consideration may be made in order for a child IAB-node to monitor a radio condition on a radio link to a parent IAB-node where the parent IAB-node may itself be a child IAB-node in communication with an IAB-donor.

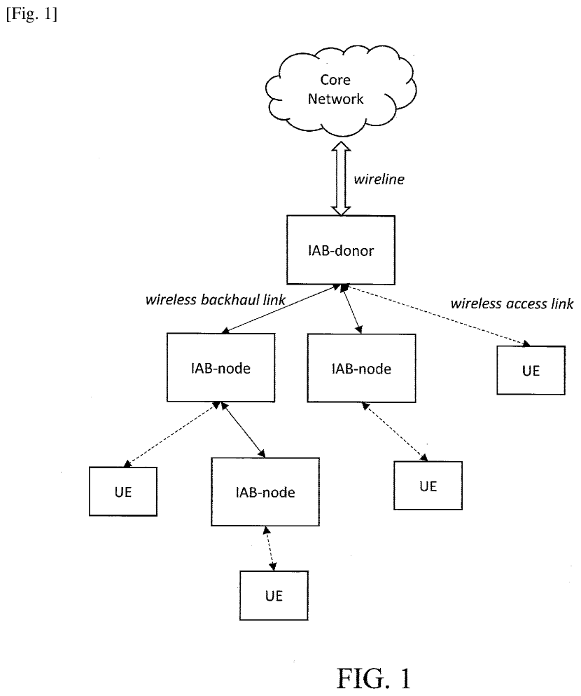

With reference to FIG. 1, the present embodiments include a mobile network infrastructure using 5G signals and 5G base stations (or cell stations). Depicted is a system diagram of a radio access network utilizing IAB nodes, where the radio access network may comprise, for example, one IAB-donor and multiple IAB-nodes. Different embodiments may comprise different number of IAB-donor and IAB-node ratios. Herein, the IAB nodes may be referred to as IAB relay nodes. The IAB-node may be a Radio Access Network (RAN) node that supports wireless access to UEs and wirelessly backhauls the access traffic. The IAB-donor is a RAN node which may provide an interface to the core network to UEs and wireless backhauling functionality to IAB nodes. An IAB-node/donor may serve one or more IAB nodes using wireless backhaul links as well as UEs using wireless access links simultaneously. Accordingly, network backhaul traffic conditions may be implemented based on the wireless communication system to a plurality of IAB nodes and UEs.

With further reference to FIG. 1, a number of UEs are depicted as in communication with IAB nodes, for example, IAB nodes and IAB donor node, via wireless access link. Additionally, the IAB-nodes (child nodes) may be in communication with other IAB-nodes and/or an IAB-donor (all of which may be considered IAB parent nodes) via wireless backhaul link. For example, a UE may be connected to an IAB-node which itself may be connected to a parent IAB-node in communication with an IAB-donor, thereby extending the backhaul resources to allow for the transmission of backhaul traffic within the network and between parent and child for integrated access. The embodiments of the system provide for capabilities needed to use the broadcast channel for carrying information bit(s) (on the physical channels) and provide access to the core network.

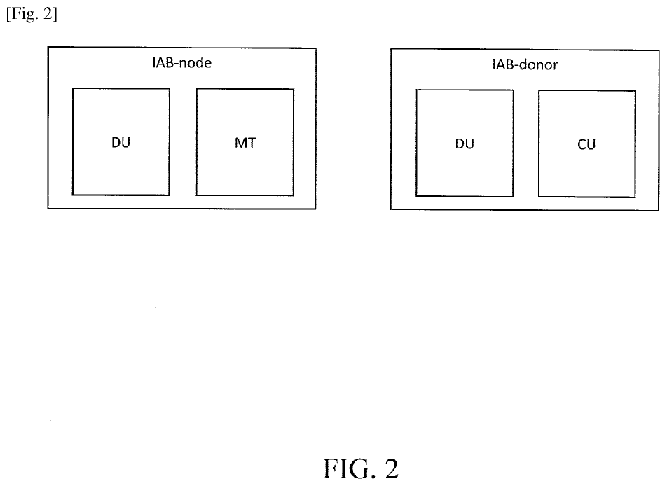

FIG. 2 depicts an example of functional block diagrams for the JAB-donor and the IAB-node (see FIG. 1). The IAB-donor may comprise at least one Central Unit (CU) and at least one Distributed Unit (DU). The CU is a logical entity managing the DU collocated in the IAB-donor as well as the remote DUs resident in the IAB-nodes. The CU may also be an interface to the core network, behaving as a RAN base station (e.g., eNB or gNB). In some embodiments, the DU is a logical entity hosting a radio interface (backhaul/access) for other child IAB-nodes and/or UEs. In one configuration, under the control of CU, the DU may offer a physical layer and Layer-2 (L2) protocols (e.g., Medium Access Control (MAC), Radio Link Control (RLC), etc.) while the CU may manage upper layer protocols (such as Packet Data Convergence Protocol (PDCP), Radio Resource Control (RRC), etc.). An IAB-node may comprise DU and Mobile-Termination (MT) functions, where in some embodiments the DU may have the same functionality as the DU in the IAB-donor, whereas MT may be a UE-like function that terminates the radio interface layers. As an example, the MT may function to perform at least one of: radio transmission and reception, encoding and decoding, error detection and correction, signaling, and access to a SIM.

Embodiments include a mobile network infrastructure where a number of UEs are connected to a set of IAB-nodes and the IAB-nodes are in communication with each other for relay and/or an IAB-donor using the different aspects of the present embodiments. In some embodiments, the UE may communicate with the CU of the IAB-donor on the C-Plane using RRC protocol and in other embodiments, using Service Data Adaptation Protocol (SDAP) and/or Packet Data Convergence Protocol (PDCP) radio protocol architecture for data transport (U-Plane) through NR gNB. In some embodiments, the DU of the IAB-node may communicate with the CU of the IAB-donor using 5G radio network layer signaling protocol: F1 Application Protocol (F1-AP*) which is a wireless backhaul protocol that provides signaling services between the DU of an IAB-node and the CU of an IAB-donor. That is, as further described below, the protocol stack configuration may be interchangeable, and different mechanism may be used.

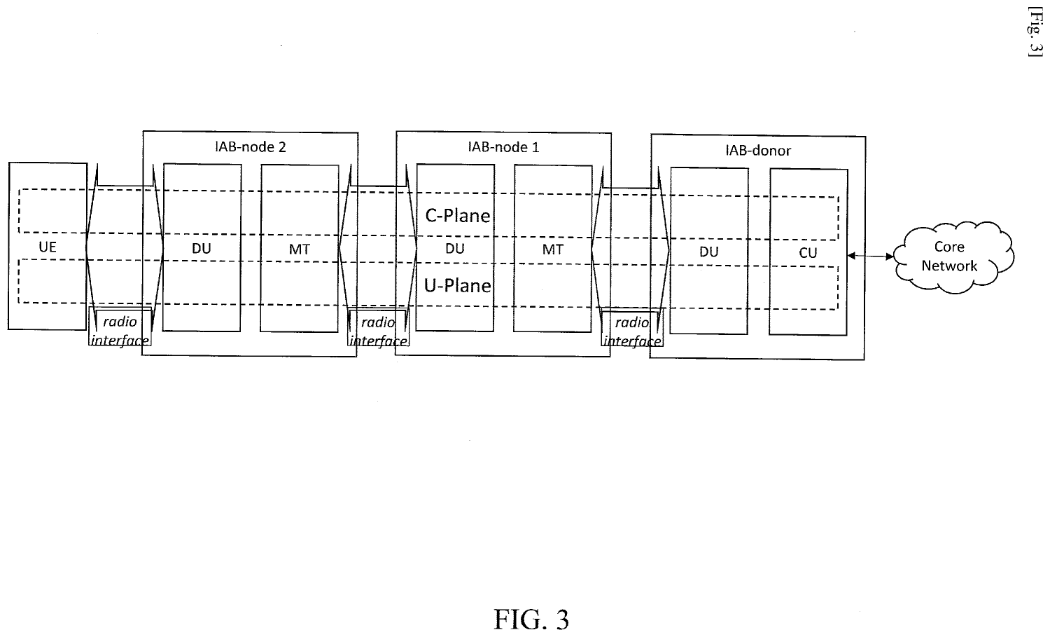

As illustrated by the diagram shown in FIG. 3, the protocols among the UE, IAB-nodes, and IAB donor are grouped into Control Plane (C-Plane) and User Plane (U-Plane). C-Plane carries control signals (signaling data), whereas the U-Plane carries user data. FIG. 3 shows an example of the embodiment where there are two IAB-nodes, IAB-node 1 and IAB-node 2, between the UE and the IAB-donor (two hops). Other embodiments may comprise a network with a single hop or multiple hops where there may be more than two IAB-nodes present.

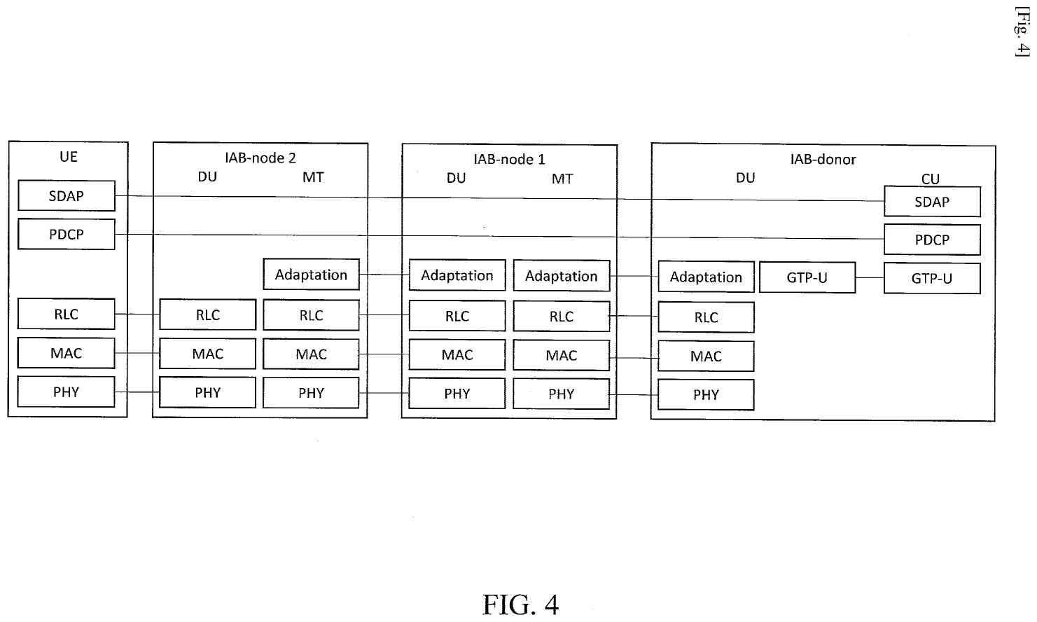

FIG. 4 depicts a functional block diagram of an example protocol stack configuration for the U-Plane, the stack comprising Service Data Protocol (e.g., SDAP, 3GPP TS 38.324) which may carry user data (e.g., via JP packets). In one embodiment, the SDAP runs on top of PDCP (3GPP TS 38.323) and the L2/Physical layers. In one embodiment, an Adaptation Layer is introduced between the IAB-node and the IAB-node/donor, where the Adaptation Layer carries relay-specific information, such as IAB-node/donor addresses, QoS information, UE identifiers, and potentially other information. In this embodiment, RLC (3GPP TS 38.322) may provide reliable transmission in a hop-by-hop manner while PDCP may perform end-to-end (UE-CU) error recovery. GTP-U (GPRS Tunneling Protocol User Plane) may be used for routing user data between CU and DU inside the IAB-donor.

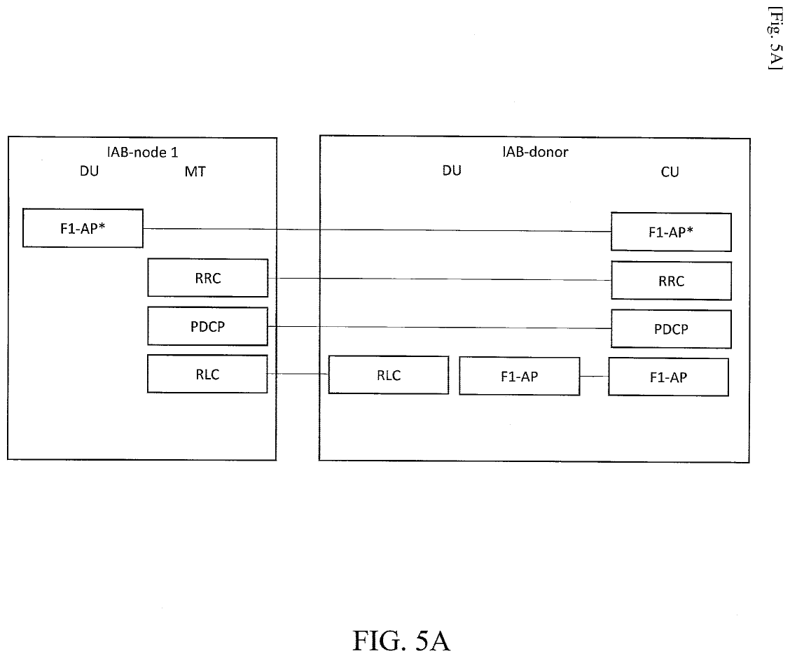

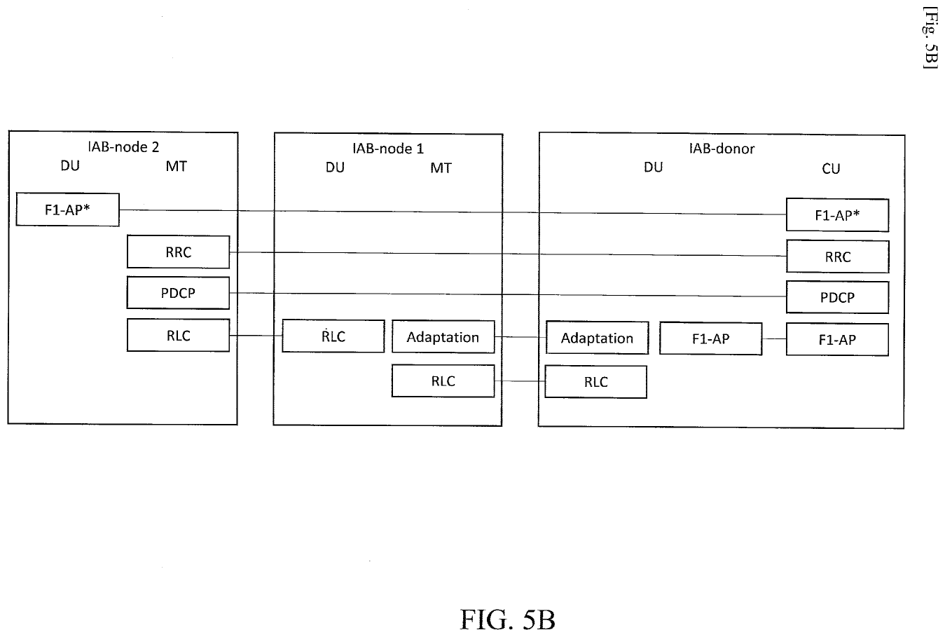

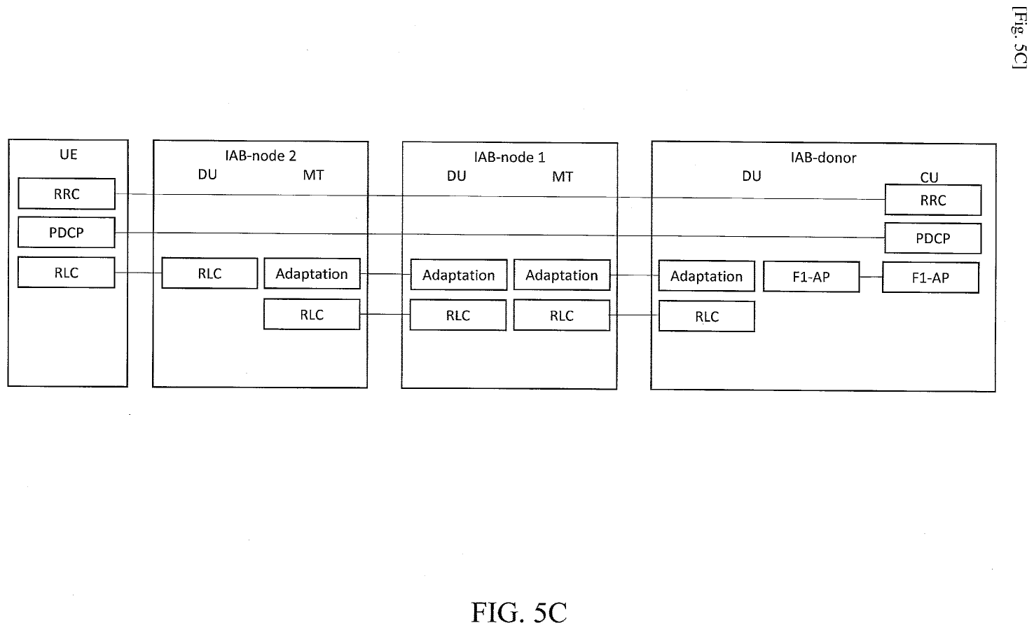

FIG. 5A is a functional block diagram of an example protocol stack configuration for the C-Plane between an IAB-node (IAB-node 1) directly connected to the IAB-donor (via a single hop). In this embodiment, the MT component of IAB-node 1 may establish an RRC connection with the CU component of the IAB-donor. In parallel, RRC may be used for carrying another signaling protocol in order for CU/IAB-donor to control the DU component resident in the IAB-node 1. In one embodiment, such a signaling protocol may be referred to as F1 Application Protocol* (F1-AP*), a protocol based on F1-AP specified in 3GPP TS 38.473 and described above, with potential extended features to accommodate wireless backhauls (the original F1-AP is designed for wirelines). In other embodiments, F1-AP may be used for CU-DU connection inside the IAB-donor. It is assumed that below RLC, MAC/PHY layers are shared with the U-Plane.

FIG. 5B depicts a functional block diagram of an example configuration of the C-Plane protocol stack for IAB-node 2, an IAB-node connected to the aforementioned IAB-node 1 (2 hops). In one embodiment, it may be assumed that the IAB-node 1 has already established RRC/F1-AP* connections with the IAB-donor as shown in FIG. 5A. In IAB-node 1 the signaling bearer for IAB-node 2 RRC/PDCP may be carried by the Adaptation Layer to the IAB-donor. Similar to FIG. 5A, the F1-AP* signaling is carried by the RRC of IAB-node 2.

FIG. 5C depicts yet another functional block diagram of an example configuration of the C-Plane protocol stack for UE's RRC signaling under the 2-hop relay configuration shown in FIG. 5B. Accordingly, the UE having an MT component and functionality, via the C-Plane, may be connected to the CU of the IAB-donor. Though traffic is routed through IAB-node 2 and IAB-node 1, as depicted, the two nodes are passive nodes in that the data is passed to the next node(s) without manipulation. That is, data is transmitted by the UE to the node it is connected to, e.g., IAB-node 2, and then IAB-node 2 transmits the data to the node that is connected to, e.g., IAB-node 1, and then IAB-node 1 transmits the data (without manipulation) to the IAB-donor.

FIGS. 5A, 5B, and 5C illustrate that the MT of each IAB-node or UE has its own end-to-end RRC connection with the CU of the JAB-donor. Likewise, the DU of each IAB-node has an end-to-end F1-AP* connection with the CU of the IAB-donor. Any IAB nodes present between such end points transparently convey RRC or F1-AP signaling traffic.

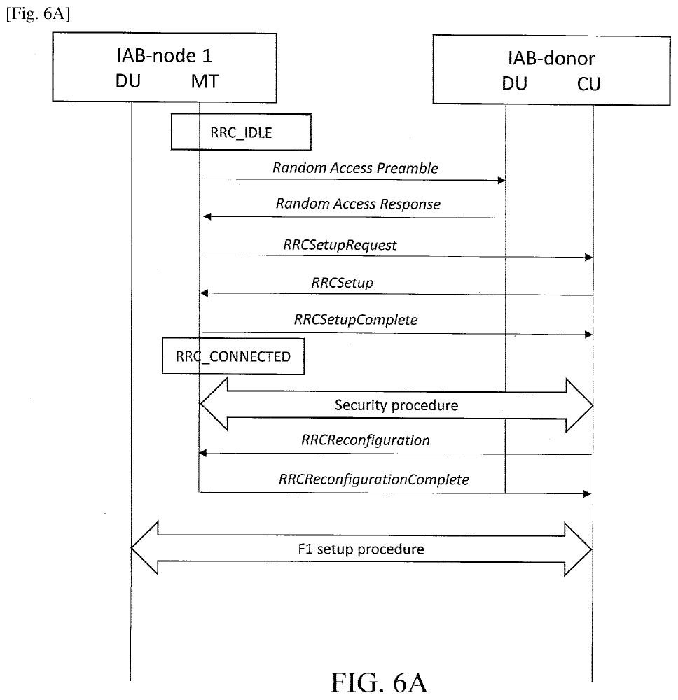

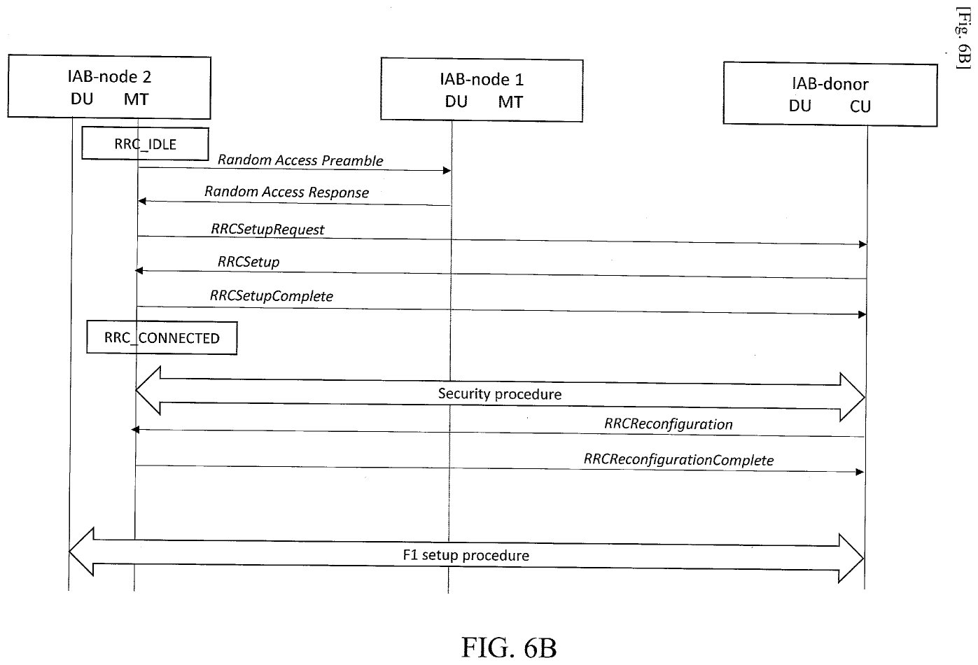

FIGS. 6A and 6B are diagrams of an example flow of information transmit/receive and/or processing by IAB-node(s) and an IAB-donor according to aspects of the present embodiments.

FIG. 6A depicts an example message sequence for IAB-node 1 to establish an RRC connection, followed by F1-AP* connection. It is assumed that IAB-node 1 has been pre-configured (or configured by the network) with information that instructs how to select a cell served by the IAB-donor. As shown in the figure, IAB-node 1 in an idle state (RRC_IDLE) may initiate an RRC connection establishment procedure by sending Random Access Preamble to the IAB-donor, which may be received and processed by the DU of the IAB-donor. Upon successful reception of Random Access Response from the IAB-donor, IAB-node 1 may send a RRCSetupRequest, followed by reception of an RRCSetup and transmission of RRCSetupComplete. At this point of the message sequence, the IAB-node 1 may enter a connected state (RRC_CONNECTED) with the IAB-donor, and may proceed with a security procedure to configure encryption/integrity protection features. The CU of the IAB-donor may further send an RRCReconfiguration to IAB-node 1, which may comprise configuration parameters to configure radio bearers (e.g., data radio bearers (DRBs) and signaling radio bearers (SRBs)). In some embodiments, the RRCReconfiguration is sent to modify an RRC connection and establish Radio Connection between a UE and the network, however, in the present embodiment, the RRCReconfiguration may also be sent to configure a connection between an IAB-node and the network. RRC Connection Reconfiguration messages may be used to, for example, establish/modify/release Radio Bearers, and/or perform handover, etc. In one embodiment, any of the RRC messages transmitted from IAB-node 1 may include information identifying the IAB-node 1 as an IAB-node (not as a UE). For example, the Donor CU may be configured with a list of node identities (e.g., IMSI or S-TMSI) that may be allowed to use the service from the donor. The information may be used by the CU in the subsequence operations, for example, to distinguish a UE from an IAB-node.

As described above, following the RRC connection establishment procedure, the DU of IAB-node 1 and IAB-donor may proceed with F1 setup procedure using the F1-AP* protocol, which may activate one or more cells served by the DU of IAB-node 1 thereby allowing other IAB nodes and/or UEs to camp on the cell. In this procedure, the Adaptation Layer for IAB-node 1 and IAB-donor may be configured and activated as well.

FIG. 6B depicts an example message sequence or flow of information for JAB-node 2 to establish an RRC connection with IAB-donor, followed by the F1 setup procedure. It is assumed in this embodiment that IAB-node 1 has already performed the process disclosed in FIG. 6A to establish an RRC and F1-AP* connection. Referring back to FIG. 3, the IAB-node 2 shown in communication via the radio interface with IAB-node 1, may be also depicted in FIG. 6B as a child node of IAB-node 1 according to aspects of the present embodiments.

Due to the nature of wireless communications, the wireless backhaul links are susceptible to be deteriorated or broken at any time. In aspects of the present embodiments, the MT part of an IAB-node may constantly monitor the quality of the radio link and/or signal quality on the upstream of the IAB-node, where the radio link may be to a parent IAB node/donor of the IAB-node. If radio problems cannot be recovered in a designated duration, the MT may declare Radio Link Failure (RLF), meaning a loss of communication link may have occurred or signal strength is weak to continue (e.g., below a threshold).

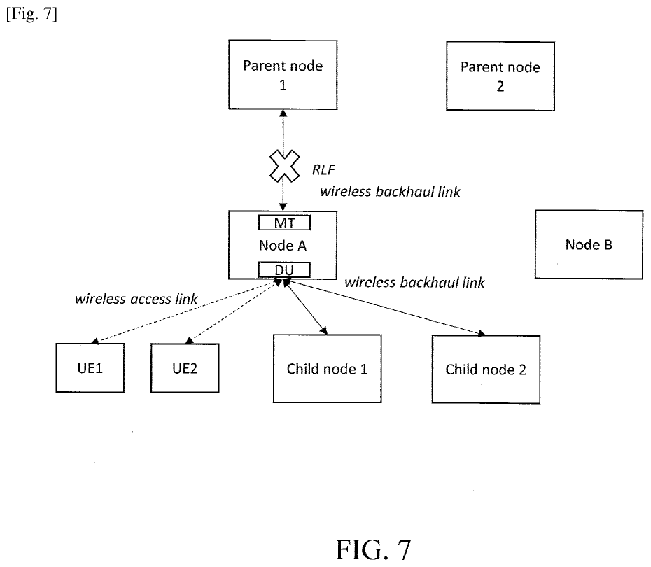

FIG. 7 shows an example diagram of a scenario where an IAB-node (Node A) detects RLF on the upstream link to its parent node (Parent node 1). In some embodiments, the MT component of Node A may need to find another parent that is visible from the node. In this case, the MT component may perform a cell selection procedure, and if a suitable cell (Parent node 2) is successfully found, the Node A may then proceed with an RRC reestablishment procedure with the suitable cell (Parent node 2). It should be noted that Node A in this scenario needs to find a cell served by either an IAB-node or an IAB-donor (i.e., non-IAB-capable cells are not suitable). In one embodiment, a cell served by either an IAB-node or an IAB-donor may broadcast (e.g., in the system information) a state, e.g., via a flag, as an indication indicating the IAB capability. Alternatively, or in parallel, Node A may have been pre-configured or configured by the network with a list of IAB-capable cell identifications.

While Node A is trying to find a new suitable IAB-capable serving cell, the child IAB nodes (Child node 1 and Child node 2) and/or UEs (UE1 and UE2) may still be in connected mode with Node A. If Node A successfully recovers from the RLF before expiration of a pre-configured (or network-configured) period of time, the child nodes and/or the UEs may not be aware of the RLF. However, in the scenario where Node A fails or has failed to recover from the RLF in a timely manner (e.g., before expiration of a pre-configured/network-configured period of time), not only may these child nodes/UEs suffer discontinuity of service, but also all the nodes/UEs in the downstream may also suffer discontinuity of service.

The present embodiments disclose systems, methods, and device where an IAB-node may inform connected nodes (child nodes) or UEs, of the upstream radio conditions. In some embodiments, the upstream radio condition information may enable the child nodes or UEs to decide to stay connected with the IAB-node or to look for another node to connect to.

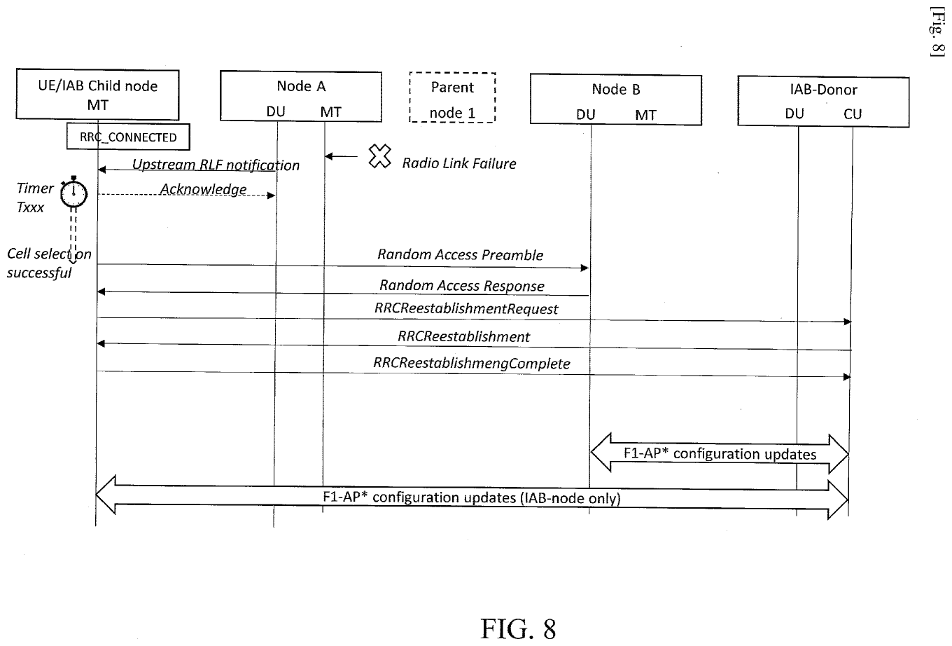

FIG. 8 shows an example scenario for Upstream RLF notification, a notification of an RLF, sent from a node (Node A) and detected on the node's upstream, to the child nodes and/or the directly connected UEs. In one embodiment, upon receiving the notification, each of the child nodes and/or UEs may perform cell selection and, if successful, proceed to RRC reestablishment. As shown in FIG. 8, each of the child nodes and/or UEs, after a successful selection to a new node (Node B), may start the reestablishment procedure through Node B. That is, once a successful selection is made, the child nodes and/or UEs may transmit Random Access Preamble/Response messages, followed by RRCReestablishmentRequest and subsequent messages as illustrated in FIG. 8.

In one embodiment, Upstream RLF notification may be carried by the Adaptation Layer (e.g., a header part or a message body of the Adaptation Layer protocol). In an alternate embodiment, or in addition to, the notifications may be carried by the RLC sublayer, MAC, or a physical layer signaling (e.g., PDCCH). Additionally, the notifications may be broadcasted via system information or transmitted in a dedicated manner.

Accordingly, in one embodiment, RRC resident in each of the child nodes and/or UEs may perform cell selection upon receiving a notification indicating the reception of the Upstream RLF notification from lower layers. In the present embodiments, this may be performed even if the radio link to the parent node remains in good condition. The node and/or UE may then start a timer, timer Txxx (e.g., T311 specified in 3GPP TS 38.331), based on the received notification, and upon selecting a suitable cell while timer Txxx is running, the node and/or UE may stop timer Txxx and initiate transmission of RRCReestablishmentRequest to the IAB-donor.

Once the RRC connection is reestablished, the CU of the IAB-donor may update the F1-AP* configurations in Node B as well as the child IAB-node that initiated the RRC reestablishment. In the scenario where the connecting device is a UE, F1-AP* configuration updates are not needed as they do not have the F1-AP* interface. Accordingly, the updated configuration from the IAB-donor may be used to reconfigure the routing topology which was modified or changed due to the RLF.

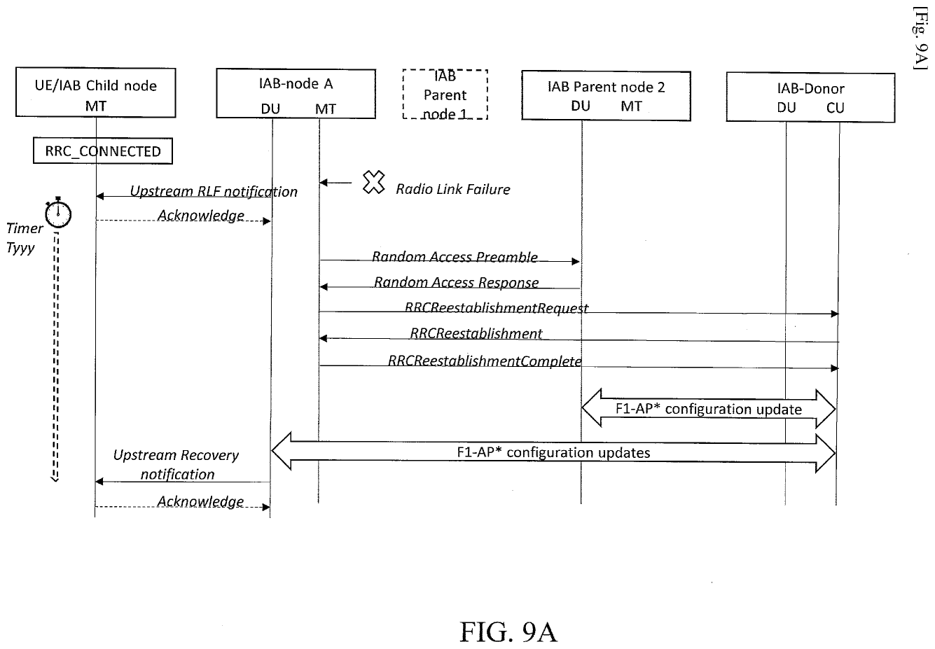

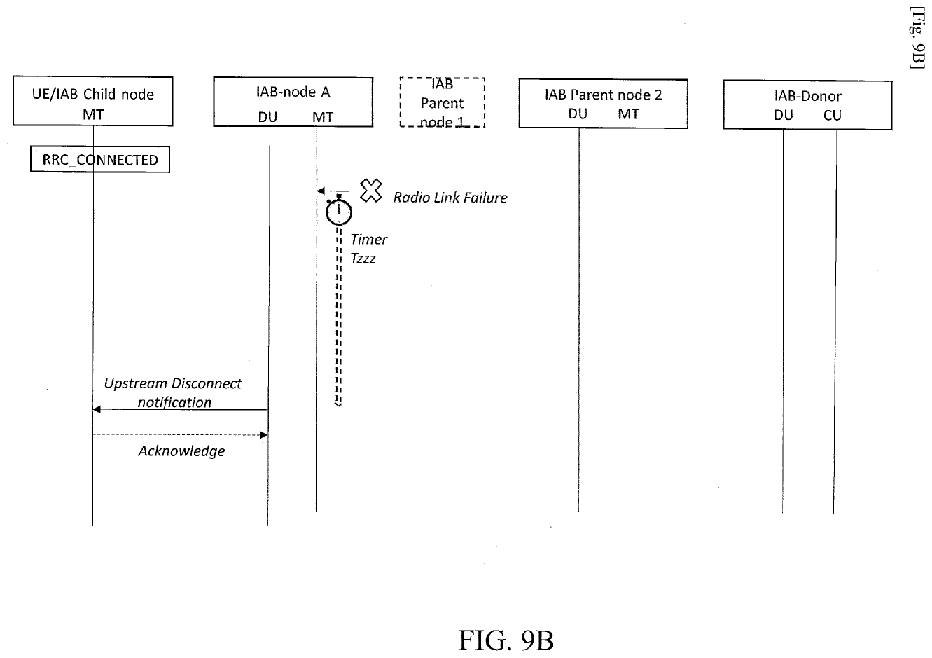

FIG. 9A shows another scenario where the child nodes and/or UEs may start a timer, for example, timer Tyyy, based on receiving an Upstream RLF notification. While the timer Tyyy is running, Node A may attempt to recover the upstream link by performing cell selection. In the scenario depicted in FIG. 9, Node A has successfully found a new parent node (Parent node 2) and may initiate the RRC reestablishment procedure. Node A, based on receiving F1-AP* configuration update from the CU of the IAB-donor, may transmit/send Upstream Recovery notification a notification indicating that the upstream is recovered to the child IAB-node and/or the UEs. If timer Tyyy has not expired yet, the child IAB-node and/or the UEs that receive the notification may stop timer Tyyy and stay connected with Node A. If the timer expires before receiving Upstream Recovery notification, the child IAB-node and/or the UEs may perform cell selection/RRC reestablishment as shown in FIG. 8. In one embodiment, the timer value/configuration may be pre-configured. In another embodiment, the timer value/configuration may be configured by the parent node (e.g., Parent node 1) via a dedicated signaling or via a broadcast signaling (e.g., system information).

Similar to the previous scenario, in one embodiment, the Upstream RLF notification may be carried by the Adaptation Layer, RLC, MAC, or a physical layer signaling. Additionally, the notifications may be broadcasted via system information or transmitted in a dedicated manner.

In yet another embodiment for this scenario, RRC resident in each of the child nodes and/or UEs may start timer Tyyy upon receiving Upstream RLF notification from the lower layers. If the node and/or UE receive a notification indicating the reception of the Upstream RLF notification from lower layers while timer Tyyy is running, the node and/or UE may stop timer Tyyy. If timer Tyyy expires, the node and/or UE may then start timer Txxx and upon selecting a suitable cell while the timer is running, the node and/or UE may stop the timer and initiate transmission of RRCReestablishmentRequest.

FIG. 9B shows yet another scenario where Node A may start a timer Tzzz upon detecting an RLF. In this scenario, Node A may or may not send the aforementioned Upstream RLF notification to the child IAB-nodes and/or UEs. While the timer Tzzz is running, Node A may attempt to recover the upstream link by performing cell selection. In the scenario depicted in FIG. 9B, at the timer Tzzz expiry (cell selection failure), Node A may send a notification (e.g. Upstream Disconnect notification) to the child IAB-nodes/UEs notifying the unsuccessful RLF recovery. In this case, the child IAB-nodes/UEs that receive the notification may start the aforementioned timer Txxx and initiate the cell selection procedure as shown in FIG. 8. The notification may be carried by the Adaptation Layer, RLC, MAC, or a physical layer signaling, in a broadcast or a dedicated manner. In one embodiment, the timers Txxx and Tzzz may be the same timer or share same configurations. In another embodiment, the timers Txxx and Tzzz may be different timers or differently configured.

Additionally, notifications that an IAB-node provides to its downstream (children/UEs) may not be limited to RLF or RLF recovery. In some embodiments, the JAB-node may inform child nodes and/or UEs of the signal quality (e.g., Reference Signal Received Power (RSRP), Reference Signal Received Quality (RSRQ)), error rates, and/or any other types of measurements that indicate the radio condition of the upstream. In this case, IAB-nodes and/or UEs may be pre-configured or configured by the network with conditions for initiating cell selection/reestablishment. The notifications may be carried by the Adaptation Layer, RLC, MAC, or a physical layer signaling, in a broadcast or a dedicated manner.

In one embodiment, upon receiving one of the notifications from the parent node, the IAB-node and/or UE may send back or respond with an acknowledgement to the parent node, as shown in FIG. 8, FIGS. 9A and 9B.

In the abovementioned embodiments, whether the child IAB-node(s) or UE(s) needs to find a new parent IAB-node or wait for the radio link recovery of current parent IAB-node may be based on when the parent node sends and/or transmits the upstream RLF notifications and how the associated timer(s) is (are) configured/triggered. The below embodiments are directed at addressing and handling the situation or conditions that occur as a result of an RLF event.

Regarding the procedures relating to an RLF, in some embodiments, while in RRC_CONNECTED state, the UE and/or child IAB-node declares a Radio Link Failure (RLF) when one of the following criteria is met:
(A) Expiry of a timer started after indication of radio problems from the physical layer (if radio problems are recovered before the timer is expired, the UE stops the timer);
(B) Random access procedure failure;
(C) RLC failure.

After RLF is declared, the UE and/or child IAB-node may:
stay in RRC_CONNECTED state;
select a suitable cell and then initiates RRC re-establishment;
enter RRC_IDLE state if a suitable cell wasn't found within a certain time after RLF was declared.

Different aspects of the embodiments disclose methods, devices, and systems to reduce the time for a downstream child IAB-node/UE to respond to an upstream RLF. That is, the child IAB-node/UE may be configured to perform specific actions when a potential upstream RLF is predicted to happen by the parent node. In some aspects with similar delivery methods of the abovementioned embodiments, an Upstream Potential RLF notification message may be sent to the child IAB-node/UE. As disclosed, the message of Upstream Potential RLF notification may be the same message as the abovementioned Upstream RLF notification, and accordingly, the two notifications may be interchangeable throughout this application to signify that the same procedures may be used to determine, process, and/or respond to Upstream Potential RLF notifications and/or Upstream RLF notifications. That is, the conditions that trigger the messages may be the same (mutually used) or different; the two messages may be used interchangeably; and/or the processing or responding to the messages may be the same or different. Additionally, the use of the Upstream Potential RLF notifications and Upstream RLF notifications is by way of examples and not limitations.

In one embodiment, the Upstream RLF notification message and/or the Upstream Potential RLF notification message may include a cell ID as part of the message in order to identify which cell has or might have RLF problems.

Timer and the Physical Layer

Regarding the abovementioned radio problems in criterion (A), the IAB-node/UE may perform measurement of radio link strength/quality for the Special Cell (SpCell); determine whether the measured radio link strength/quality is below a configured and/or preconfigured threshold; and if the measured radio link strength/quality is determined to be below the threshold, the lower layer(s), e.g., physical layer, may report a special indication, for example, “out-of-sync” indication signals, to the higher layers. In one example, if a certain number, e.g., X1 (refers to N310 defined in the spec of TS 38.331), of consecutive “out-of-sync” indication signals are received from the lower layer, then the IAB-node/UE determines that radio problems may be present and a timer, e.g., T1 (refers to T310 defined in the spec of TS 38.331), is started.

In order to send Upstream Potential RLF notification message to child nodes and UEs timely, in the present embodiments, once a certain number, e.g., X, of consecutive “out-of-sync” indication signals are indicated or received from the lower layer of the parent node, the parent node predicts that there might be radio problems and sends and/or transmits the Upstream Potential RLF notification message to the child IAB-nodes/UEs or other parent IAB-nodes. In one embodiment, the number of consecutive “out-of-sync” indications (X) may be the same as the parameter X1 mentioned above, so as to allow reuse of the same parameter. In an alternative embodiment, the number of consecutive “out-of-sync” indications may be configured or preconfigured by the network to the parent IAB-node a new parameter, e.g., X2, where, X2 is always smaller or at most no greater than X1, so as not to affect the procedures of normal RLF declaration of parent nodes.

In other embodiments, different from the timer T1 mentioned above for the purpose of declaring RLF, a new timer T2 may be configured or preconfigured by the network, where the value of T2 is smaller or at most no greater than the one of T1. When the parent node detects a certain number of consecutive “out-of-sync” indications, the parent node may start both T1 and T2 timers; at the expiry of T2, the parent node sends and/or transmits the Upstream Potential RLF notification message. In another alternative embodiment, T1 is not T310 any more, instead, when the parent node detects a certain number of consecutive “out-of-sync” indications, the parent node may start the T2 timer only; at the expiry of T2, the timer T1 is started; in one example, the value of T1+T2 is equal to the original T310 timer value for the purpose of declaring RLF. Additionally, if T2 is configured with the value 0, it may be treated as a special case of the first embodiment. That is, in the embodiment where the timer value is set to zero, the system may proceed without any timers and accordingly use the out of sync indication signals based on the previously disclosed embodiments.

In yet another embodiment, the above two embodiments are combined. In one example, both X2 and T2 are used for the purpose of sending Upstream Potential RLF notification message timely. That is, the sending of Upstream Potential RLF notification message may be based on a combination of the configured or preconfigured parameter for the number of consecutive “out-of-sync” indications and the configured or preconfigured timer by the network. Accordingly, the parent node may start the timer, T2, and also continue to determine whether the consecutive “out-of-sync” threshold is reached in parallel and whichever is triggered first (e.g., timer expiry or reaching the threshold), the Upstream Potential RLF notification message may be sent and/or transmitted by the parent node.

Random Access Procedure Failure

Regarding the abovementioned Random access procedure failure in criterion (B), in some embodiments, the information element (IE)

PREAMBLE_TRANSMISSION_COUNTER may be used to record how many times the transmission/retransmission of PRACH preamble fails, if the number of failures reaches some configured and/or preconfigured maximum number of transmissions, e.g., Y1, the parent node declares an RLF.

In some embodiments, a new parameter may be used for PRACH preamble transmission, e.g., Y2, which is the threshold to trigger delivery of the Upstream Potential RLF notification message. This new parameter (Y2), may be configured and/or preconfigured by the network and assigned to the parent node. If the transmission of PRACH preamble of the parent node has reached the Y2 threshold number, the parent node sends and/or transmits the Upstream Potential RLF notification message to the child nodes and UEs. Optionally, in one embodiment, a timer may be used to track the failed PRACH preamble transmission attempts where the timer provides an alternative method to determine an event where the timer or expiration of the timer may trigger the notification to be sent and/or transmitted.

Radio Link Control (RLC) Failure Regarding the abovementioned RLC failure in criterion (C), similar to criterion (B), the retransmission of RLC layer data unit is also allowed until a maximum allowed number of transmissions, e.g., Z1, is reached.

Additionally, in some embodiments, a new parameter associated with an RLC retransmission number, e.g., Z2, which is the threshold to trigger delivery of the Upstream Potential RLF notification message, may be configured and/or preconfigured by the network and assigned to the parent node. If the RLC retransmission of parent node has reached the Z2 number, the parent node sends and/or transmits the Upstream Potential RLF notification message to the child nodes and UEs.

Similar to the previous embodiment, an optional timer may be used to track the failed RLC transmission attempts where the timer provides an alternative method to determine an event where the timer or expiration of the timer may trigger the notification to be sent and/or transmitted.

Processing after RLF or Potential RLF is Declared

In some aspects of the different embodiments, based on receiving an Upstream Potential RLF notification message by the child IAB-node/UE as described above, the child IAB-node/UE may perform at least one of the following operations:
select a suitable cell (parent node) and initiate RRC re-establishment;
select one or multiple suitable cell(s) (parent nodes) and initiate establishment of redundancy link(s) in the way of dual connectivity or carrier aggregation;
if the child IAB-node/UE already has dual/multiple connectivity to more than one parent node at the time of receiving the Upstream Potential RLF notification message from one of the parent nodes, the child IAB-node/UE may determine, based on implementation, the next action or step that needs to be executed. That is, the child IAB-node/UE may determine that no further/extra operation is needed if no priority is configured to the cell in a certain cell group associated with dual/multiple connectivity. For example, cell groups may be primary cells in the list of primary cell group and secondary cells in the list of secondary cell group. In another embodiment, the child IAB-node/UE may determine to change the serving or scheduling cell in the cell list according to the priority of the cell in the cell list—for the case where the network configures priority for cells related to dual connectivity and/or carrier aggregation. In one embodiment, when the serving cell has radio link failure problems, another parent node for cell connection may take control of backhaul traffic for the child IAB-node/UE based on the parent node of the cell having the second highest priority.

In some aspects of the different embodiments, the original parent IAB-node's may measure the radio link strength/quality on the physical layer and then predict potential problems. The parent IAB-node may then transmit a notification to another parent node by way of an Upstream Potential RLF notification message. Based on receiving the Upstream Potential RLF notification message by another parent JAB-node, the other parent IAB-node may perform the operations of initialize a Random access procedure with the child IAB-node/UE connected with the original parent IAB-node. Thereby an RRC connection is established with the child node by the other (new) IAB-parent.

With reference to the below descriptions of the figures, different embodiments are used to further describe and illustrate various or several aspects of the disclosed systems, devices, and methods.

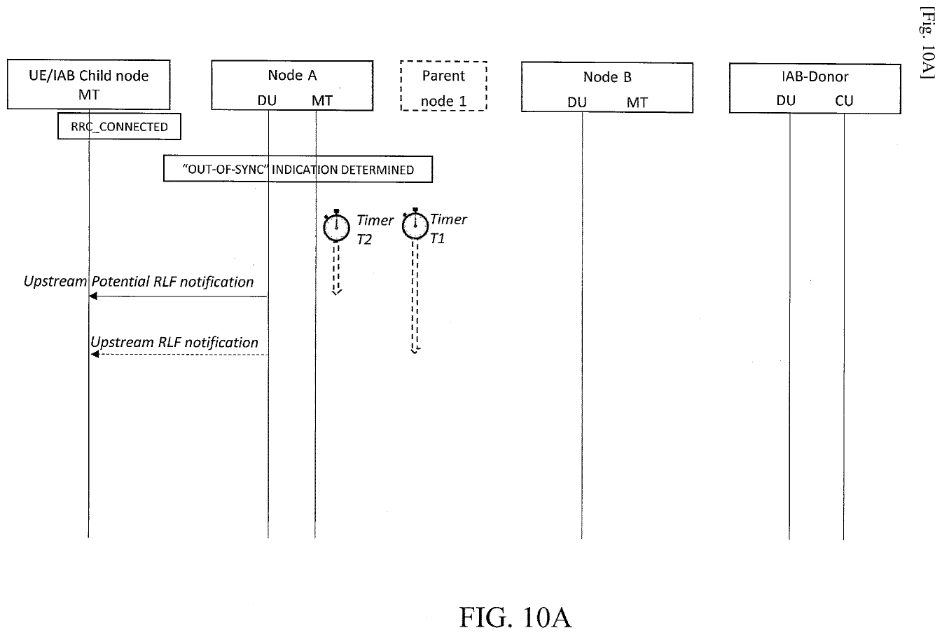

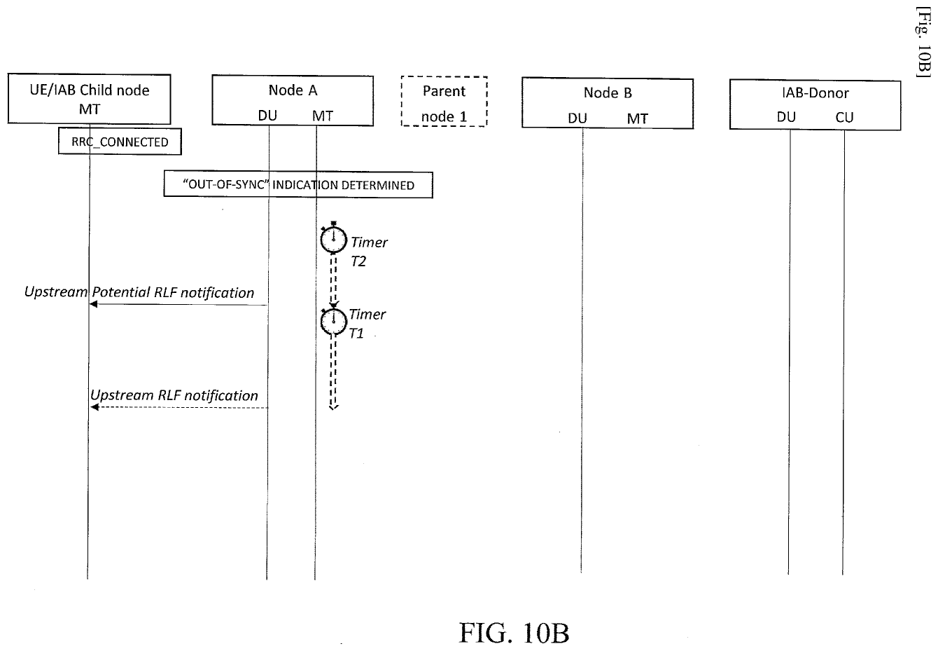

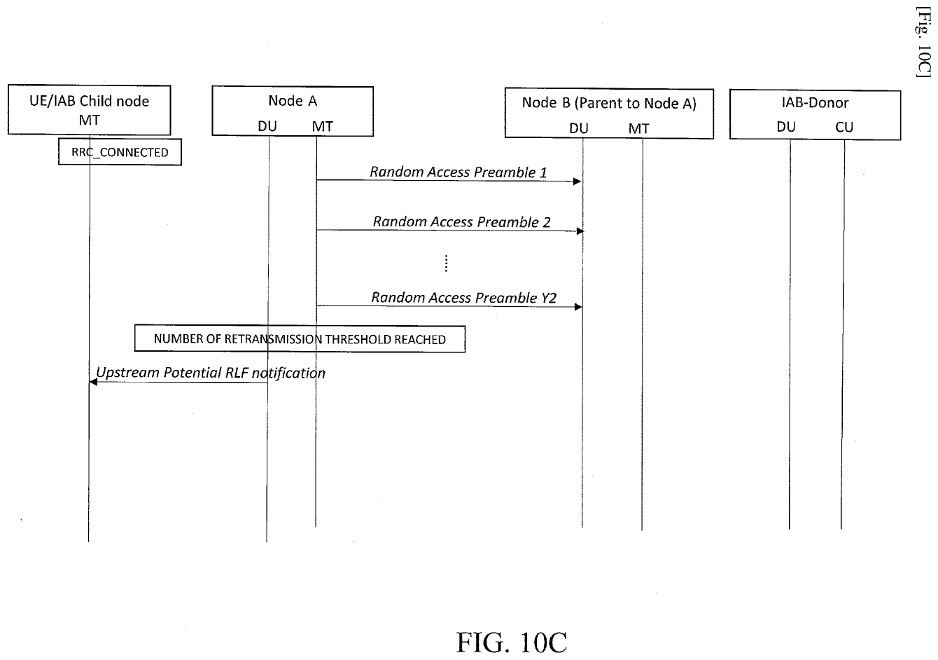

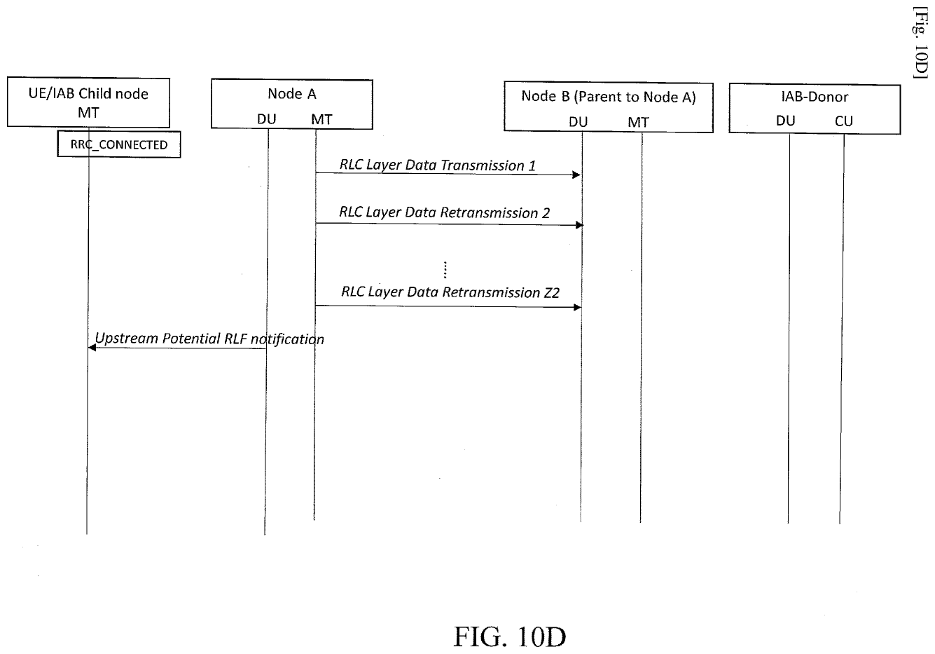

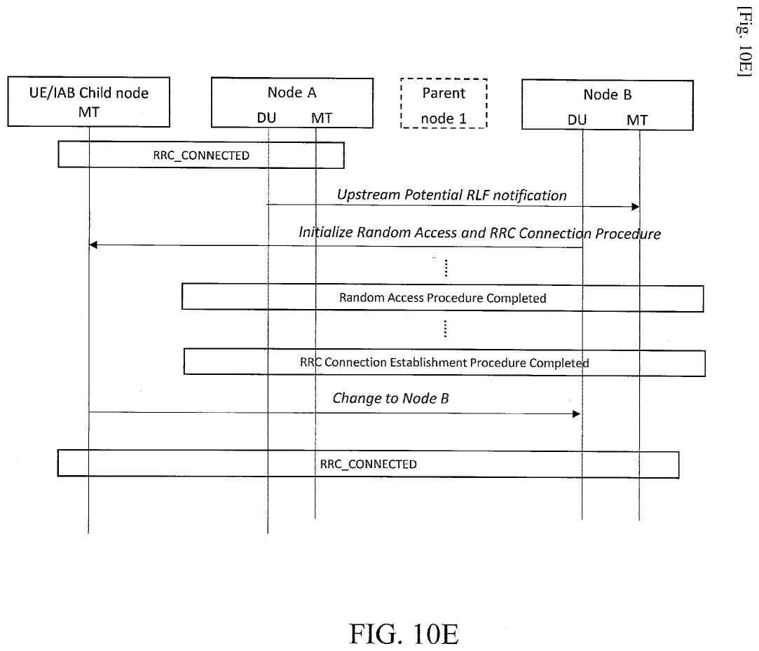

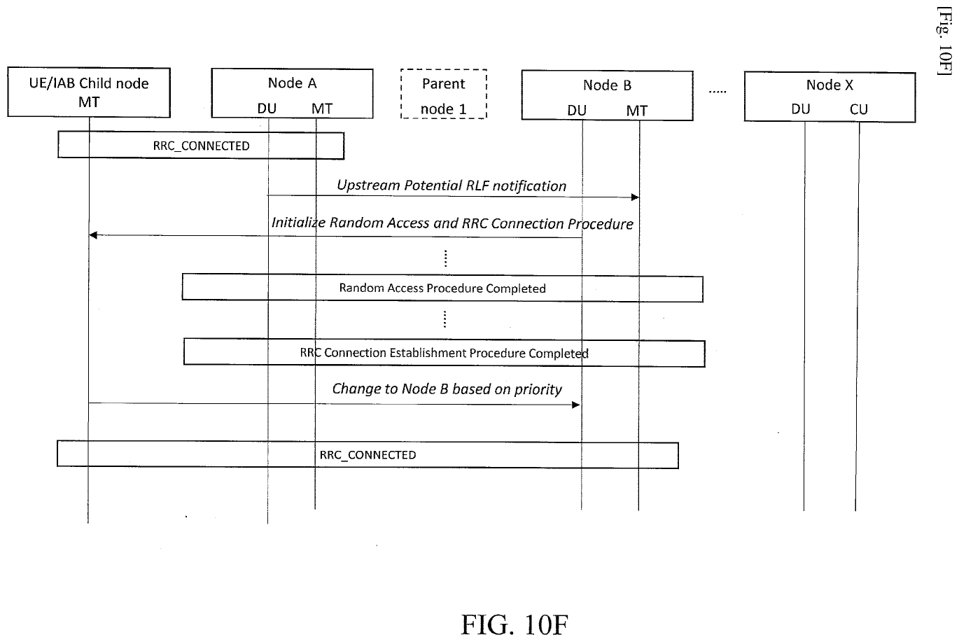

FIG. 10A shows an example scenario for Upstream Potential RLF notification, a notification based on higher layers on the IAB-node having determined that a number of “out-of-sync” indications from the lower layer(s) have reached a threshold. The figure further depicts this communication, sent from a node (Node A) and detected on the node's physical layer by measurement of radio link strength/quality, as transmitted to the UE/IAB-child node. FIG. 10A further depicts different embodiments having a timer implemented as part of the notification determination. As described previously, based on a number of detected “out-of-sync” indications, the parent node (Node A) may implement a timer T2, configured or preconfigured by the network, where the value of T2 is smaller or at most no greater than the timer T1. That is, when the parent node (Node A) detects a certain number of consecutive “out-of-sync” indications, the parent node may start both T1 and T2 timers simultaneously in some embodiments. Further, at the expiration of the timer T2, the parent node sends and/or transmits the Upstream Potential RLF notification message. In addition, in an optional embodiment, upon the expiration of timer T1, which may have been started simultaneously with T2, an Upstream RLF notification may be transmitted to the UE/IAB-child node.

FIG. 10B shows another example scenario similar to FIG. 10A where in this embodiment, when the lower layer(s) of the parent node detects a certain number of consecutive “out-of-sync” indications, the parent node may start the timer T2 initially. This figure then depicts the embodiment where at the expiration of T2, an Upstream Potential RLF notification is transmitted to the UE/IAB child node and then the timer T1 is started. In addition, in an optional embodiment, upon the expiration of timer T1, which may have been started in a serial fashion with T2, an Upstream RLF notification may be transmitted to the UE/IAB-child node.

In both FIG. 10A and FIG. 10B, timer T2 may be configured or set with a value of zero, where the timers may be disregarded and not used in determining when to transmit Upstream Potential RLF notification to other nodes.

FIG. 10C shows another example scenario for Upstream Potential RLF notification, where the notification is based on higher layers on the IAB-node having determined that a number of PRACH preamble transmission attempts have failed. In this figure, the PRACH preamble transmission failures are calculated by use of a counter, for example, an IE, and if the count reaches the threshold Y2, it triggers delivery of the Upstream Potential RLF notification message by the node to other nodes. As described previously, this parameter Y2 may be configured and/or preconfigured by the network and assigned to the parent node. That is, with further reference to FIG. 10C, once the failed transmission count of PRACH preamble of the parent node (Node A) has reached the Y2 threshold number, the parent node (Node A) may make the determination and sends and/or transmits the Upstream Potential RLF notification message to the UE/IAB-child node. The parent node (Node A) may optionally continue to calculate the number of failed PRACH preamble transmission attempts using the same (or different) counter, and if the failed transmission count of PRACH preamble of the parent node (Node A) has reached another threshold Y1, the parent node sends and/or transmits an Upstream RLF notification.

FIG. 10D shows another example scenario for Upstream Potential RLF notification, where the notification is based on higher layers on the IAB-node having determined that a number of RLC Layer Data transmission attempts have failed. In this figure, the RLC Layer Data transmission failures are calculated by use of a counter, for example, an IE, and if the count reaches the threshold Z2, it triggers delivery of the Upstream Potential RLF notification message by the node to other nodes. As described previously, this parameter Z2 may be configured and/or preconfigured by the network and assigned to the parent node.

FIG. 10E depicts an example message sequence for a parent IAB-node in communication with another parent IAB-node and UE/IAB Child node. In this figure, Node A and Node B are both parent nodes to the UE/IAB child node with dual connectivity (or carrier aggregation shown in FIG. 10F). With further reference to FIG. 10E, UE/IAB Child node is in an RRC_Connected mode with Node A but based on the disclosed embodiments, if Node A determines that there might be radio link failure problems or there is already a radio link failure, parent node (Node A) may send and/or transmit an Upstream Potential RLF notification or Upstream RLF notification to the other parent node (Node B) informing the other parent node to UE/IAB Child node of the potential failure with Node A's radio link. That is, Node B may then take control of the radio link connection by initializing a Random Access Procedure and RRC connection establishment procedure. After a Random Access Procedure is successfully completed and an RRC connection establishment procedure also completed, the connection may automatically change for the UE/IAB Child node to be in RRC_Connected mode with Node B. Accordingly, Node B may become the serving cell for UE/IAB Child node based on the Upstream Potential RLF notification being sent to the other parent node (Node B) from the first parent node (Node A).

With reference to FIG. 10F, in an embodiment supporting carrier aggregation, a number of other parent IAB-nodes (Node X) are depicted as being part of the serving cell group to UE/IAB Child node. Accordingly, based on the Upstream Potential RLF notification to the other parent nodes, the Random Access Procedure and RRC Connection Establishment Procedure are with Node B as initially Node A was the highest priority in the group and Node B was the second highest priority and so after the link failure with Node A, Node B would have the highest priority and selected based on having the highest priority of the group Node A, Node B . . . Node X. In this example, should Node X have had a higher priority than Node B, the change based on the Upstream Potential RLF notification to the other parent nodes would have been to Node X with higher priority than Node B.

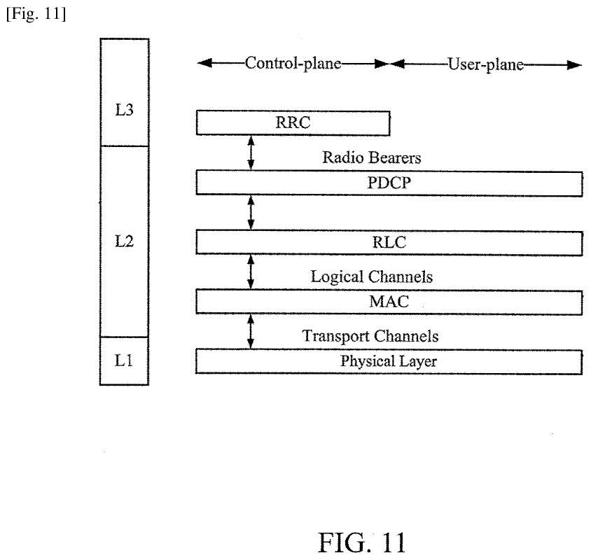

FIG. 11 is a diagram illustrating an example of a radio protocol architecture for the control and user planes in a mobile communications network. The radio protocol architecture for the UE and/or the gNodeB may be shown with three layers: Layer 1, Layer 2, and Layer 3. Layer 1 (L1 layer) is the lowest layer and implements various physical layer signal processing functions. Layer 2 (L2 layer) is above the physical layer and responsible for the link between the UE and/or gNodeB over the physical layer. In the user plane, the L2 layer may include a media access control (MAC) sublayer, a radio link control (RLC) sublayer, and a packet data convergence protocol (PDCP) sublayer, which are terminated at the gNodeB on the network side. Although not shown, the UE may have several upper layers above the L2 layer including a network layer (e.g., IP layer) that is terminated at the PDN gateway on the network side, and an application layer that is terminated at the other end of the connection (e.g., far end UE, server, etc.). The control plane also includes a radio resource control (RRC) sublayer in Layer 3 (L3 layer). The RRC sublayer is responsible for obtaining radio resources (i.e., radio bearers) and for configuring the lower layers using RRC signaling between the IAB-nodes and/or the UE and an IAB-donor.

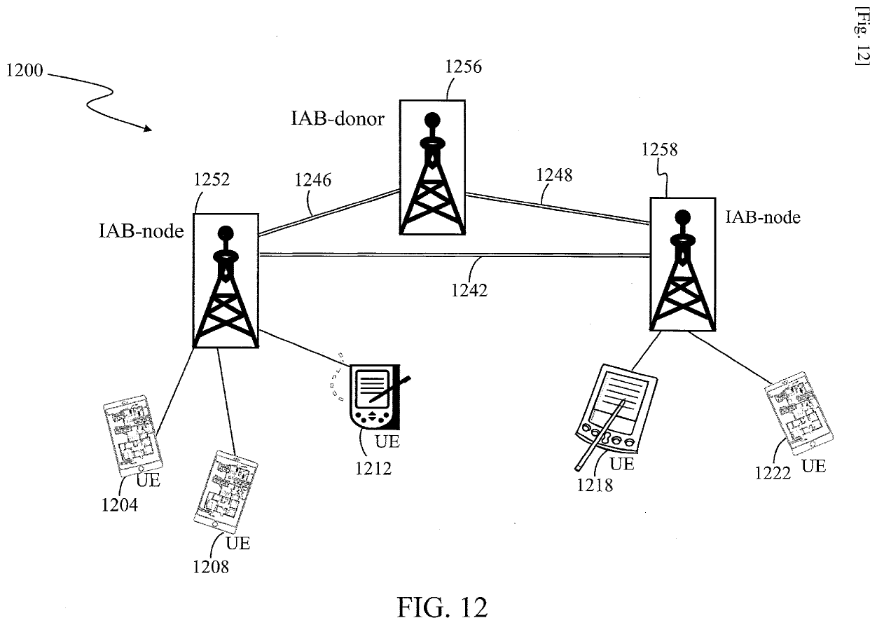

FIG. 12 depicts an example of a mobile network infrastructure 1200 where a number of UEs and IAB-nodes, comprising components of a computing device as illustrated in FIG. 11, are illustrated in communication with each other. In one embodiment, a plurality of UEs 1204, 1208, 1212, 1218, 1222 are connected to a set of IAB-nodes 1252, 1258 and the IAB-nodes 1252, 1258 are in communication with each other 1242 and/or an IAB-donor 1256 using the different aspects of the present embodiments. That is, the IAB-nodes 1252, 1258 may send out discovery information to other devices on the network (e.g., the Cell ID and resource configuration of the transmitting nodes are sent to the receiving node) and also provide MT functionality in connecting to the IAB-donor 1256. The examples of UEs may also be receiving discovery information and if not barred, then requesting connections and to use resources by transmitting connection requests to the JAB-nodes and/or JAB-donors. In one embodiment, an IAB-donor 1256 may limit or bar any requests from UEs for connection due to them being already connected to other IAB-nodes and committed resources to the backhaul traffic. In another embodiment, the IAB-donor 1256 may accept the UE's connection request but prioritize the IAB-node backhaul traffic over any connections used by the UE's. In yet another embodiment, the IAB-donor 1256 and/or IAB-nodes 1252, 1258 may detect and communicate RLFs according to the aspects of the current embodiments, which may then be propagated down between IAB-nodes and UEs, where the child nodes (e.g., IAB-node or UE in the network) may detect upstream connection failures.

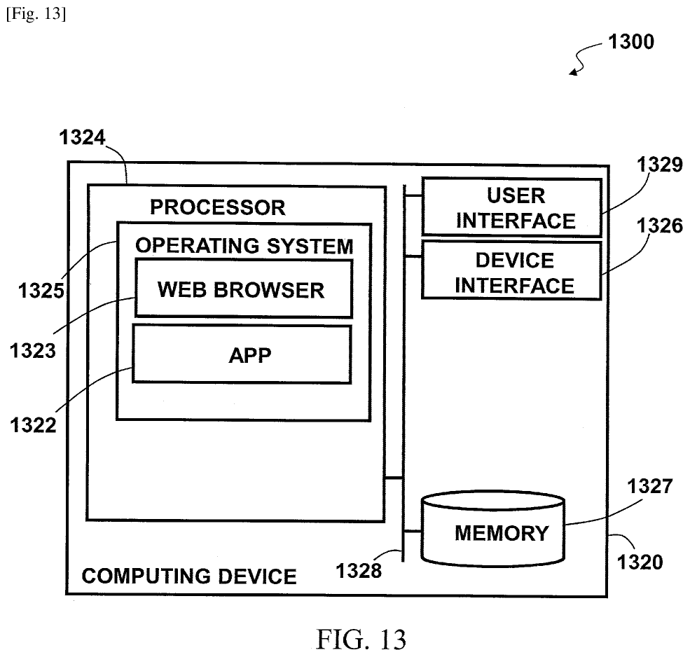

FIG. 13 illustrates an example of a top level functional block diagram of a computing device embodiment 1300. The example operating environment is shown as a computing device 1320 comprising a processor 1324, such as a central processing unit (CPU), addressable memory 1327, an external device interface 1326, e.g., an optional universal serial bus port and related processing, and/or an Ethernet port and related processing, and an optional user interface 1329, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 1328. In some embodiments, via an operating system 1325 such as one supporting a web browser 1323 and applications 1322, the processor 1324 may be configured to execute steps of a process establishing a communication channel and processing according to the embodiments described above.

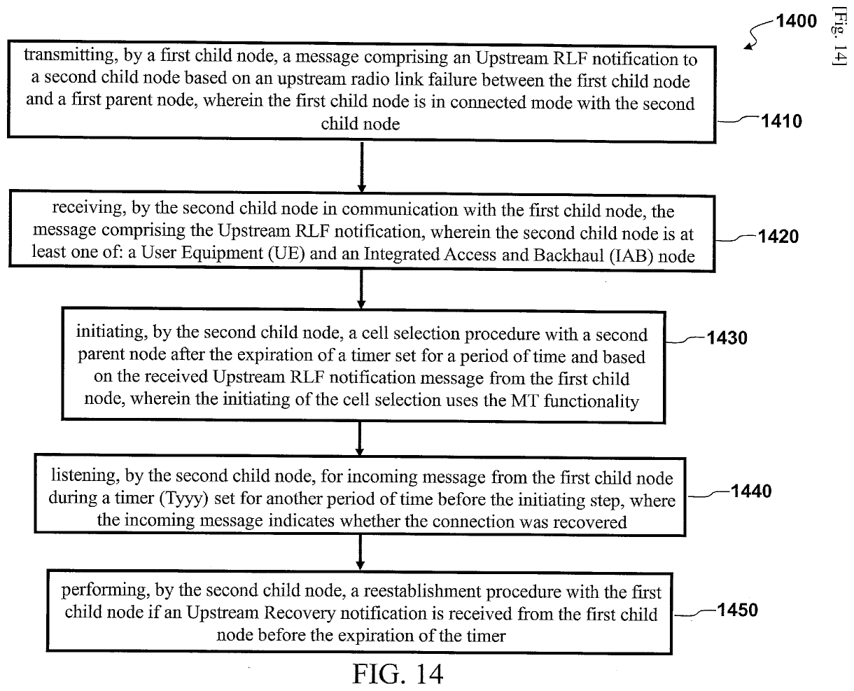

FIG. 14 is a flowchart of an exemplary process 1400 method of Handling Radio Link Failures (RLF) in a Wireless Relay Network in which the system comprises a computer and/or computing circuitry that may be configured to execute the steps as depicted. Additionally, the wireless relay network may have a donor node, a first parent node, a second parent node, a first child node, and a second child node, where the donor node may be an Integrated Access and Backhaul (IAB) node connected to a core network, and where the first parent node, the second parent node, the first child node, and the second child node each may have Mobile Termination (MT) functionality capabilities. The method depicted in the flowchart includes the steps of: (a) transmitting, by a first child node (IAB-node A), a message comprising an Upstream RLF notification to a second child node (UE/IAB Child node) based on an upstream radio link failure between the first child node and a first parent node (IAB Parent node 1), wherein the first child node is in connected mode with the second child node (step 1410); (b) receiving, by the second child node in communication with the first child node, the message comprising the Upstream RLF notification, where the second child node may be either: a User Equipment (UE) or an Integrated Access and Backhaul (IAB) node having MT capabilities (step 1420); (c) initiating, by the second child node, a cell selection procedure with a second parent node (IAB Parent node 2) before the expiration of a timer (Txxx) set for a period of time and based on the received Upstream RLF notification message from the first child node, wherein the initiating of the cell selection uses the MT functionality (step 1430); (d) listening, by the second child node, for incoming message from the first child node during a timer (Tyyy) set for another period of time before the initiating step, where the incoming message indicates whether the connection between the first child node and the first parent node was recovered (step 1440); and (e) performing, by the second child node, a reestablishment procedure with the first child node if an Upstream Recovery notification is received from the first child node that the connection between the first child node and the first parent node was recovered before the expiration of the timer.

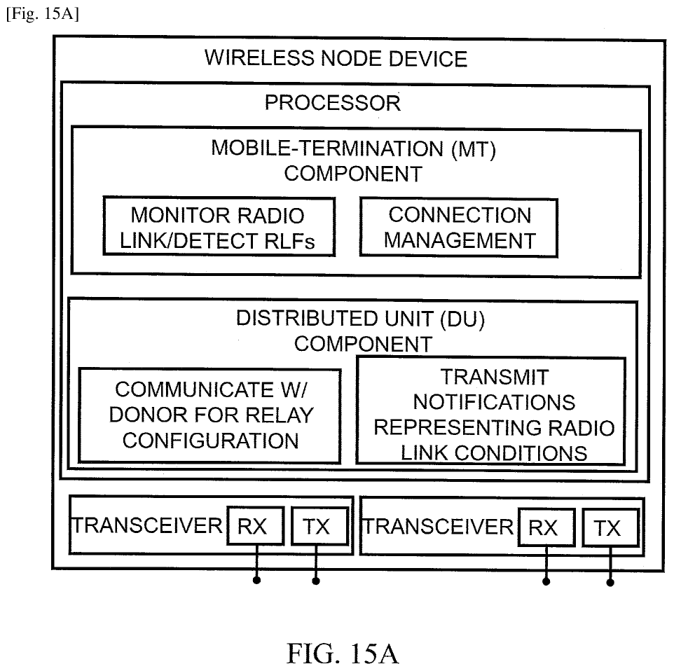

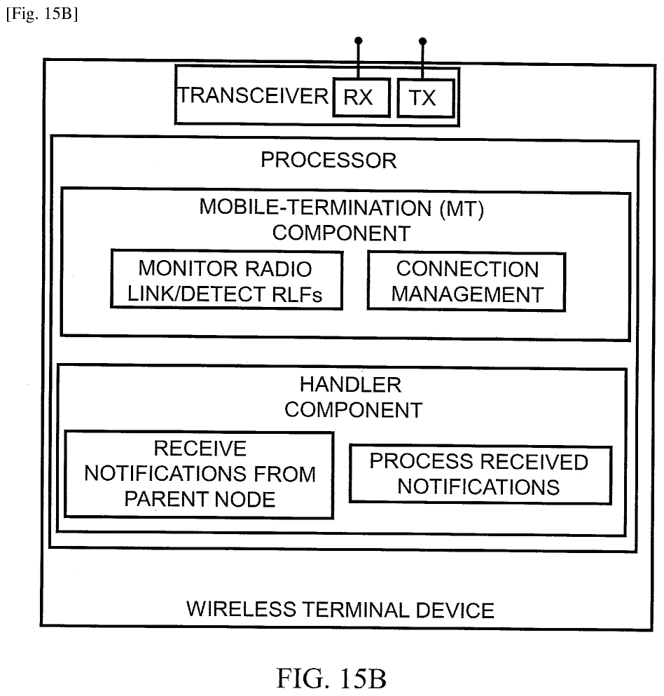

FIG. 15A is a functional block diagram of a wireless node device which may be a parent IAB-node which may be in communication with an IAB-donor upstream and a UE and/or child IAB-node downstream. The parent IAB-node may include a processor and two transceivers, where each transceiver may have a transmitter component and receiver component, and in some embodiments, one transceiver may be used for connection to and communications with upstream devices (upstream radio links) and the other used for connection to and communications with downstream devices (downstream radio links). That is, in one embodiment, one transceiver may be dedicated to communicating with IAB-donors/parent IAB-nodes (via a Mobile-Termination (MT) Component) and the other transceiver with child IAB-nodes and/or UEs (via a Distributed Unit (DU) Component). The mobile-termination component may provide a function that terminates the radio interface layers, similar to a UE but implemented on the IAB-nodes as disclosed herein. The example wireless node device depicted in FIG. 15A may further include a processor which may comprise the Mobile-Termination (MT) Component and the Distributed Unit (DU) Component. In this embodiment, the MT component may be configured to monitor the radio link and detect radio link conditions on the upstream radio links, such as Radio Link Failures (RLFs). The MT component may also include a connection management that may provide at least cell selection, connection establishment and reestablishment functionality. The DU component may be configured to communicate with the IAB-donor for relay configuration. The DU component may also be configured to process the detected radio link conditions and transmit notifications representing the radio link conditions to the downstream nodes.

FIG. 15B is a functional block diagram of a wireless terminal device which may be a UE and/or child JAB-node in communication with an JAB-donor or a parent JAB-node upstream (itself in communication with an IAB-donor). The wireless terminal device may include a transceiver having a transmitter and receiver for communicating with other IAB-donors/nodes upstream. The example wireless node device depicted in FIG. 15B may further include a processor which may comprise the Mobile-Termination (MT) Component and Handler Component. In this embodiment, the MT component may be configured to monitor the radio link and detect any Radio Link Failures (RLFs). The MT component may also include a connection management that may provide at least cell selection, connection establishment and reestablishment functionality. The handler component may be configured to receive notifications from a parent node, for example, an IAB-donor or parent IAB-node upstream, the notifications representing radio conditions of the parent node's upstream radio links. The handler component may also be configured to process the received notifications from upstream nodes according to the aspects of the different embodiments. Upon processing of the notifications, the handler component may instruct the connection management to perform designated actions (e.g. cell selection).

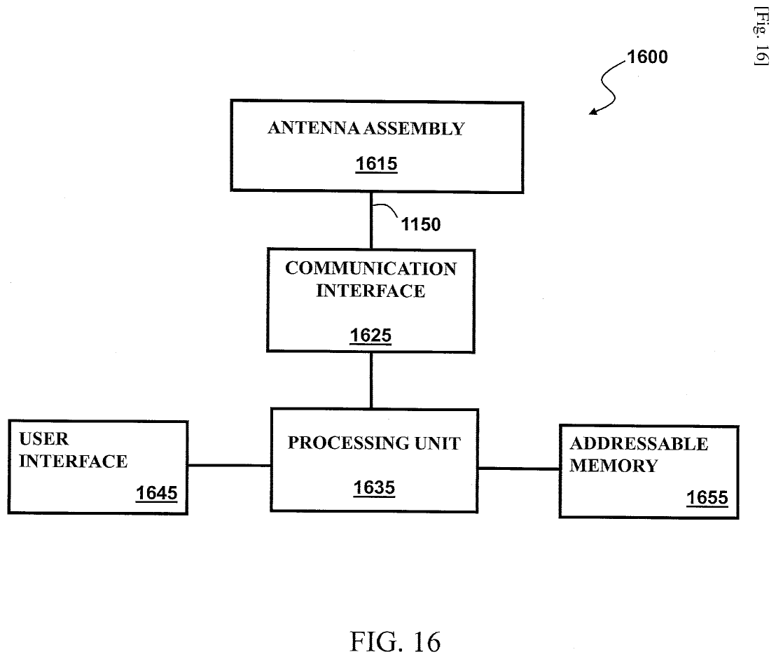

FIG. 16 illustrates an embodiment of a UE and/or base station comprising components of a computing device 1600 according to the present embodiments. The device 1600 illustrated may comprise an antenna assembly 1615, a communication interface 1625, a processing unit 1635, a user interface 1645, and an addressable memory 1655. In some embodiments, the antenna assembly 1615 may be in direct physical communication 1650 with the communication interface 1625. The addressable memory 1655 may include a random access memory (RAM) or another type of dynamic storage device, a read only memory (ROM) or another type of static storage device, a removable memory card, and/or another type of memory to store data and instructions that may be used by the processing unit 1635. The user interface 1645 may provide a user the ability to input information to the device 1600 and/or receive output information from the device 1600. The communication interface 1625 may include a transceiver that enables mobile communication device to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. The communication interface 1625 may include a transmitter that converts baseband signals to radio frequency (RF) signals and/or a receiver that converts RF signals to baseband signals. The communication interface 1625 may also be coupled (not shown) to antenna assembly 1615 for transmitting and receiving RF signals. Additionally, the antenna assembly 1615 may include one or more antennas to transmit and/or receive RF signals. The antenna assembly 1615 may, for example, receive RF signals from the communication interface and transmit the signals and provide them to the communication interface.

The abovementioned features may be applicable to 3rd Generation Partnership Project; Technical Specification Group Radio Access Network; Study on Integrated Access and Backhaul; (Release 15) for 3GPP TR 38.874 V0.3.2 (2018 June) and applicable standards.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

### CROSS REFERENCE

This Nonprovisional application claims priority under 35 U.S.C. § 119 on provisional Application No. 62/737,886 on Sep. 27, 2018, the entire contents of which are hereby incorporated by reference.

1. A method of handling Radio Link Failures (RLFs) in a wireless network, the wireless network having a donor node that is an Integrated Access and Backhaul (IAB) node connected to a core network, a first parent node (IAB-node A), a second parent node (IAB-node B), and a child node (IAB-node/UE), the method performed by the first parent node and comprising:
detecting a RLF with another node based on receiving from a physical layer of the first parent node a notification of “out-of-sync” indication signals, wherein the notification of the “out-of-sync” indication signals is determined based on at least one of measurement of radio link strength and measurement of radio link quality;
generating a message comprising an Upstream RLF notification based on when a set of one or more conditions is met; and
transmitting the message to at least one of the child node and the second parent node, wherein the second parent node is configured to establish a Radio Resource Control (RRC) connection with the child node based on the transmitted Upstream RLF notification.

2. The method of claim 1, wherein the RLF is based on signal strength of at least one of Reference Signal Received Power (RSRP) levels and Reference Signal Received Quality (RSRQ) levels associated with the RRC connection.

3. The method of claim 1, wherein the set of one or more conditions is at least one of expiration of a timer after “out-of-sync” indication signals, a number of Radio Link Control (RLC) Layer Data Retransmission failures, and a number of Random Access Preamble failures.

4. The method of claim 1, further comprising performing, by the child node, a cell reselection procedure with the second parent node, wherein the cell reselection procedure includes messaging indicating occurrence of the RLF between the first parent node and the second parent node.

5. The method of claim 1, wherein the first parent node is in a RRC connected mode with the second parent node.

6. The method of claim 1, wherein the first parent node, the second parent node, and the child node each comprises a Distributed Unit component and a Mobile Termination component.

7. The method of claim 1, wherein the Upstream RLF notification is received via at least one of an Adaptation Layer, a RLC sublayer, a Medium Access Control (MAC) sublayer, and physical layer signaling.

8. The method of claim 1, further comprising establishing, by the child node, a connection to the donor node via a cell reselection to the second parent node.

9. A first parent node equipped with at least two radio interfaces comprising a first interface and a second interface, the first interface configured to establish a first radio link with at least one parent node, the second interface configured to establish at least one radio link with one or more wireless terminals, the first parent node comprising:
processor circuitry; and
an addressable memory, wherein the processor is configured to:
detect a Radio Link Failure (RLF) with another node based on a notification from a physical layer of the first parent node and a notification of “out-of-sync” indication signals, wherein the notification of the “out-of-sync” indication signals is determined based on at least one of measurement of radio link strength and measurement of radio link quality;
generate a message comprising an Upstream RLF notification based on when a set of one or more conditions is met; and
transmit the message to at least one of the child node and the second parent node, wherein the second parent node is configured to establish a Radio Resource Control (RRC) connection with the child node based on the transmitted Upstream RLF notification.

10. The first parent node of claim 9, wherein the RLF is based on signal strength of at least one of Reference Signal Received Power (RSRP) levels and Reference Signal Received Quality (RSRQ) levels associated with the RRC connection.

11. The first parent node of claim 9, wherein the donor node comprises a Control Unit configured to provide functionality of at least one of an interface to the core network, a Control Plane, and a User Plane.

12. The first parent node of claim 9, wherein the first parent node is in a RRC connected mode with the second parent node.

13. The first parent node of claim 9, further comprising a Distributed Unit component and a Mobile Termination component.

14. The first parent node of claim 9, wherein the Upstream RLF notification is received via at least one of an Adaptation Layer, a Radio Link Control (RLC) sublayer, a Medium Access Control (MAC) sublayer, and physical layer signaling.

15. The first parent node of claim 9, further comprising:
first receiver circuitry configured to receive, from the first interface, at least one of downlink (DL) user data and DL signaling data;
first transmitter circuitry configured to transmit, to the first interface, at least one of uplink (UL) user data and UL signaling data;
second receiver circuitry configured to receive, from the second interface, at least one of the UL user data and the UL signaling data; and
second transmitter circuitry configured to transmit, to the second interface, at least one of the DL user data and the DL signaling data.

16. The first parent node of claim 9, wherein the set of one or more conditions is at least one of expiration of a timer after “out-of-sync” indication signals, a number of RLC Layer Data Retransmission failures, and a number of Random Access Preamble failures.

17. The first parent node of claim 13, wherein the second parent node and the child node each comprise the Distributed Unit component and the Mobile Termination component.

18. The method of claim 1, wherein the donor node comprises a Control Unit configured to provide functionality of at least one of an interface to the core network, a Control Plane, and a User Plane.

19. The method of claim 1, wherein the first parent node comprises a Distributed Unit component and a Mobile Termination component.

20. The method of claim 1, further comprising:
receiving at least one of downlink (DL) user data and DL signaling data;
transmitting at least one of uplink (UL) user data and UL signaling data;
receiving at least one of the UL user data and the UL signaling data; and
transmitting at least one of the DL user data and the DL signaling data.
